(19) United States
(12) Patent Application Publication
(10) Pub. No.: US 2025/0307739 A1
(43) Pub. Date: Oct. 2, 2025

(54) SYSTEM FOR DYNAMIC SCHEDULING AND OPTIMISATION OF DIAGNOSTIC TASKS

(71) Applicant: NOVUM GLOBAL GROUP PTY LTD, CARLINGFORD (AU)

(72) Inventor: Ward van der Veer, CARLINGFORD (AU)

(21) Appl. No.: 19/095,900

(22) Filed: Mar. 31, 2025

(30) Foreign Application Priority Data
Apr. 2, 2024 (AU) 2024900895

(51) Int. Cl. G06Q 10/0631; G06Q 10/04

(52) U.S. Cl. CPC G06Q 10/06314; G06Q 10/04

(57) ABSTRACT

A system is provided for dynamic scheduling and optimisation of diagnostic tasks in a networked computing environment. The system associates issue tickets with a diagnostic task matrix comprising probable causes, diagnostic tasks, probability values, outcome expectations, and resource parameters. A task scheduling controller generates optimised task sequences based on task success likelihoods, cost, technician availability, and evidentiary sufficiency. As tasks are completed, outcomes are used to update the diagnostic model, enabling automatic self-improvement. A statistical learning model, such as a

Bayesian or neural network, refines diagnostic probabilities using historical data. Integration with calendaring systems allows real-time rescheduling based on personnel availability. A graphical interface supports live drag-and-drop reconfiguration of task associations, with immediate propagation of updates to task probabilities and cost metrics. The system thereby enhances resolution speed, accuracy, and resource efficiency across evolving operational contexts.

### FIELD OF THE INVENTION

This disclosure relates to systems for technical issue resolution and, more particularly, to a computer-implemented system for dynamic scheduling and automatic optimisation of diagnostic tasks based on factors such as real-time resource availability, diagnostic task characteristics, and historical resolution data.

### BACKGROUND OF THE INVENTION

Issue tracking systems are widely used in technical support and infrastructure management to log, prioritise, and resolve problems encountered by users or detected within a computing environment. These systems typically operate using a queue-based mechanism, such as first-in-first-out (FIFO), in which issues are addressed in the order they are received or manually re-prioritised. While this approach may provide a basic level of organisation, it does not effectively account for variations in resource availability, task complexity, or the likelihood of particular causes. In many cases, diagnostic workflows are static, relying on predetermined troubleshooting scripts or manual expertise to determine a resolution path. This can result in inefficient use of technical personnel, inconsistent resolution quality, and delayed issue remediation. There is a need for an adaptive system that supports dynamic task scheduling based on real-time and historical data to improve diagnostic outcomes across varying operational contexts.

### SUMMARY OF THE DISCLOSURE

Described herein is a system comprising a processor operably interfacing with storage media that includes application controllers and data for dynamically scheduling diagnostic tasks associated with technical issues. The system comprises a ticket controller configured to receive and store issue tickets, and a diagnostic task matrix controller configured to associate each issue ticket with a diagnostic task matrix. The matrix defines a plurality of probable causes, each associated with a probability, and a plurality of diagnostic tasks each associated with one or more probable causes. Each diagnostic task is further associated with required resources and an outcome expectation categorisation, which indicates an expected likelihood of resolving the associated cause.

A user interface controller is configured to present a graphical interface for displaying and editing the diagnostic task matrix and to receive inputs indicating completion and outcome of diagnostic tasks. A task scheduling controller analyses the diagnostic task matrix, including the probabilities, resource constraints, and outcome expectation categorisations, to determine an optimised scheduling priority for the tasks. As tasks are completed and their results recorded via the interface, the diagnostic task matrix controller updates the probabilities and outcome expectation categorisations accordingly.

Through this feedback mechanism, the system may achieve automatic self-optimisation by computationally adjusting the diagnostic task matrix in response to task result inputs received during live operation. As diagnostic tasks are completed and their outcomes recorded, the system programmatically recalculates the probability distributions associated with probable causes and updates outcome expectation categorisations using defined statistical models. These updates are persistently stored and propagated to subsequent scheduling operations. As a result, the system dynamically reconfigures task prioritisation based on performance data, enabling the scheduling controller to select diagnostic tasks that are increasingly aligned with context-specific resolution patterns. This continuous model refinement enhances the system's technical performance by reducing redundant diagnostics, lowering expected resolution cost, and accelerating issue remediation through real-time adaptation to evolving infrastructure and operational characteristics.

In some embodiments, the required resources associated with each diagnostic task may optionally include a task duration estimate, a cost value, and a technical capability requirement. By incorporating these parameters into the scheduling logic, the system can generate diagnostic task sequences that are not only effective but also resource-aware, reducing overall resolution time and avoiding unnecessary allocation of high-cost or unavailable personnel.

The system may optionally interface with a calendaring server to retrieve real-time personnel availability data. This integration enables the scheduling controller to dynamically adjust task assignments in response to current availability of qualified personnel. Such real-time responsiveness is technically advantageous in environments where resource constraints fluctuate, allowing diagnostic workflows to proceed without delay or manual coordination.

In certain configurations, the diagnostic task matrix may include priority values explicitly assigned to individual tasks. These priorities may be used in combination with other scheduling parameters to influence task ordering, allowing administrative or policy-based guidance to be factored into automated scheduling decisions. This enhances the system's adaptability to operational policies without compromising its data-driven optimisation capability and improves computational efficiency by constraining the scheduling search space to favour higher-priority tasks.

The system may further assign each diagnostic task a diagnostic confidence level, which is used to compute a corresponding evidence value via a defined exponential function. These evidence values are used to assess the sufficiency of diagnostic coverage across hypotheses and to compute updated probability values based on the outcomes of completed tasks. This evidentiary model supports structured and scalable reasoning about diagnostic reliability, enabling the system to adaptively allocate resources based on quantified diagnostic certainty and to prioritise high-value tasks with greater precision.

In certain embodiments, the system computes an optimal traversal path through the diagnostic matrix by solving a constrained optimisation problem. This optimisation may incorporate task cost, duration, success likelihood, and resource availability, ensuring that the selected diagnostic path reflects the lowest expected resolution cost. By using formal optimisation techniques, the system ensures a quantifiable improvement over heuristic or manual diagnostic approaches, providing consistent, scalable task sequencing while reducing unnecessary processing overhead during schedule generation.

The system may further incorporate a statistical learning model, such as a Bayesian network or neural network, to refine probability values and outcome expectations based on historical diagnostic performance. This model may be trained on resolution data, including issue type, task sequence, resolution outcomes, and contextual metadata, enabling the system to identify environment-specific diagnostic patterns and improve over time. The learning model allows the system to anticipate the most likely root causes and effective tasks across diverse infrastructure contexts.

In certain implementations, the scheduling controller may use historical task outcome data to suppress redundant diagnostics and prioritise historically effective task sequences. This data-driven suppression may reduce unnecessary computational overhead associated with evaluating low-value or historically ineffective diagnostic paths.

The user interface may optionally support drag-and-drop reconfiguration of diagnostic task associations and execution order. When such changes are made, the system dynamically recalculates and stores updated matrix parameters, including probability values and cost metrics, in real time. This technical feature enables agile matrix refinement and immediate feedback during administrative configuration or exploratory scenario planning, while reducing the need for full matrix recomputation and thereby improving the overall responsiveness and computational efficiency of the system.

In some embodiments, the scheduling controller may compute an opportunity cost for each diagnostic task based on task cost and its coverage across multiple hypotheses. The task with the lowest opportunity cost may be selected as the next indicated task. In addition, the system may evaluate alternate tasks by estimating their expected value relative to the theoretical value of perfect information, allowing superior alternatives to be chosen when justified. This framework enables the system to operate with enhanced computational efficiency and decision quality, allowing for faster task selection, improved diagnostic accuracy, and reduced system processing overhead during real-time scheduling operations. Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a diagnostic task schedule optimising system in accordance with an embodiment;

FIG. 2 shows a server of the system;

FIG. 3 shows a computer terminal of the system;

FIG. 4 shows an exemplary graphical user interface comprising a diagnostic task matrix representation; and

FIG. 5 shows exemplary processing by the system.

### DESCRIPTION OF EMBODIMENTS

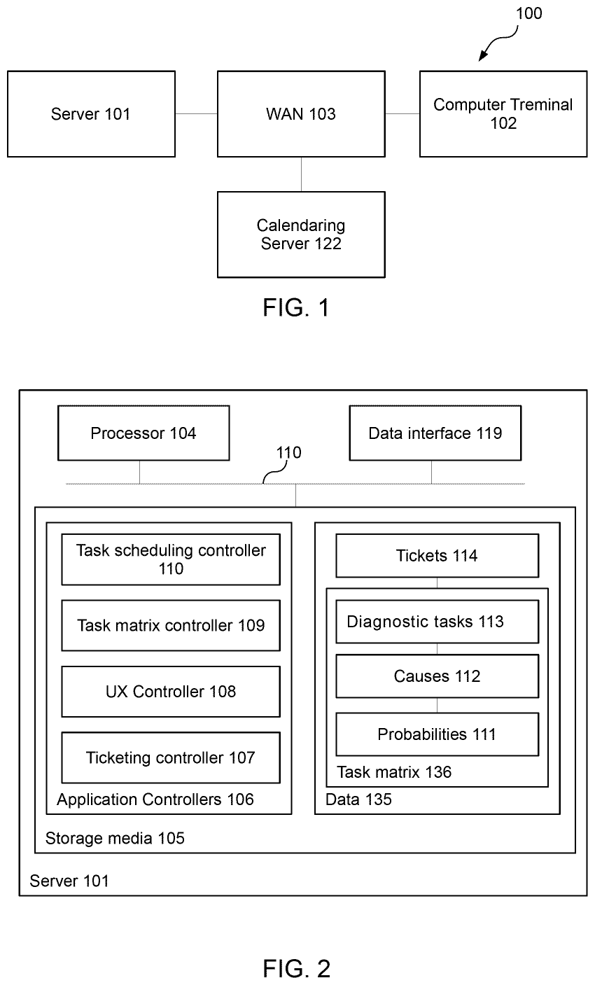

FIG. 1 shows a diagnostic task schedule optimising system 100 in accordance with a network-based embodiment comprising a server 101 in operable communication with at least one computer terminal 102 across a wide area network 103, such as the Internet. The server 101 may be further in operable communication with a calendaring server 122, which provides personnel availability data for scheduling purposes, as described in further detail below.

FIG. 2 shows the server 101 in further detail, comprising a processor 104 configured for processing digital data and operably communicating with storage media 105 via a system bus 110. The storage media 105 stores digital data including computer program code instructions, which may be logically divided into a plurality of application controllers 106. The storage media 105 further stores associated data 135, including issue ticket records, diagnostic task matrices, and historical resolution data.

In use, the processor 104 fetches and executes the program code instructions and the associated data 135 to implement the described functionality of the system 100. The server 101 includes a data interface 119 for communicating with the computer terminal 102 and the calendaring server 122 via the wide area network 103.

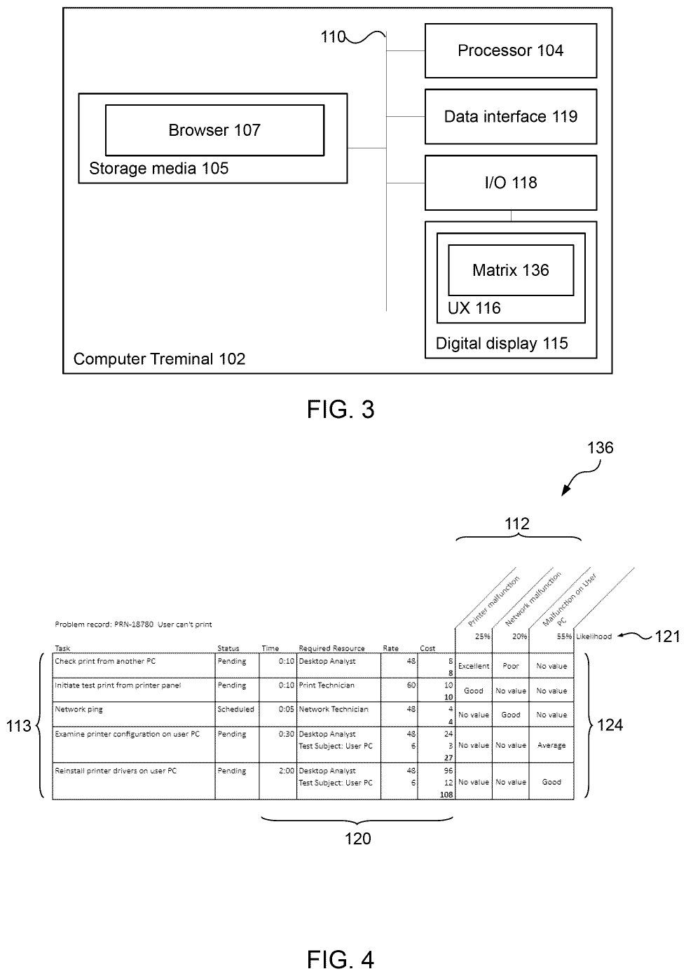

FIG. 3 shows the computer terminal 102 in further detail, also comprising a processor 104 and storage media 105. In the embodiment shown, the computer terminal 102 includes a web browser 107 configured to access web resources hosted by the server 101. The terminal further comprises an I/O interface 118 operably connected to a digital display 115, which displays a user interface 116 comprising a diagnostic task matrix 136 as shown in FIG. 4.

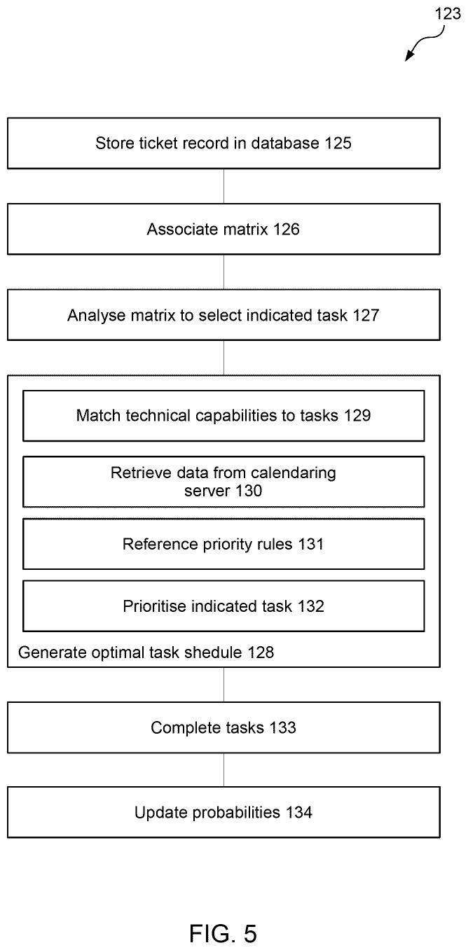

FIG. 5 shows exemplary processing 123 performed by the system 100. At step 125, the ticket controller stores an issue ticket 114 in the storage media 105. The ticket may represent an operational fault, such as a failure to print, and may be identified by a ticket ID such as PRN-18780.

At step 126, the diagnostic task matrix controller 109 associates a diagnostic task matrix 136 with the issue ticket 114. The matrix 136 includes a plurality of probable causes 112, each associated with a probability 121, and a set of diagnostic tasks 113 associated with the probable causes. Each diagnostic task 113 is further associated with required resources 120 including technical skill, estimated time to perform the task, and a task cost. The task matrix 136 also includes an outcome expectation categorisation 124 for each task, indicating the expected efficacy of the task in resolving each associated probable cause.

The user interface controller 108 is configured to generate a graphical interface 116 for editing and interacting with the diagnostic task matrix 136. Through this interface, users may add, remove, or modify probable causes and diagnostic tasks, including by way of drag-and-drop functionality. The interface further includes a task completion input, which allows a user to indicate completion of a diagnostic task and to input whether or not the task resolved the issue, via a task result input.

At step 128, the task scheduling controller 110 generates an optimised task schedule by analysing the diagnostic task matrix 136 with reference to the required resources 120, the probability values 121, and the outcome expectation categorisations 124. At step 129, the task scheduling controller considers the technical capabilities required for each task and selects tasks that are executable by available personnel. Availability information is retrieved at step 130 from the calendaring server 122, which stores calendar data for technical personnel. The task scheduling controller further considers estimated task durations and cost values stored in the task matrix 136 when generating the task schedule. At step 132, the task scheduling controller may also take into account task priority values, if specified in the matrix 136.

Each probable cause in the diagnostic task matrix is initially assigned a probability value that quantifies the estimated likelihood that the respective cause is responsible for the reported issue. These probability values are stored in association with the corresponding probable cause records and are accessed by the task scheduling controller during task prioritisation operations. The system uses these values to estimate the informational yield of candidate diagnostic tasks and to select tasks that most efficiently differentiate between competing hypotheses. By incorporating these probabilities into the scheduling logic, the system prioritises diagnostic efforts toward the most plausible fault pathways, thereby increasing resolution efficiency and reducing unnecessary investigation.

The outcome expectation categorisation assigned to each diagnostic task represents a numerical or categorised indicator of the expected diagnostic utility of the task for resolving associated probable causes. These values are considered alongside the probability values during task selection. Tasks with high outcome expectations and strong associations with probable causes of high likelihood are ranked more highly by the task scheduling controller, which uses a weighted prioritisation algorithm to balance these factors against task cost and resource constraints.

As diagnostic tasks are completed and corresponding result inputs are received via the user interface, the diagnostic task matrix controller updates both the probability values and the outcome expectation categorisations. The probability values are adjusted using probabilistic update rules informed by the task outcomes, reflecting increased or decreased likelihood of the associated causes based on whether the task supported or refuted the hypothesis. Outcome expectation categorisations are similarly refined based on observed effectiveness, allowing the system to demote tasks that repeatedly fail to yield diagnostic value and promote those that consistently contribute to successful resolution.

These updates are computationally applied in real time and persistently written to the storage media. As a result, the system incrementally adapts its prioritisation logic based on empirical diagnostic performance, creating a closed feedback loop that progressively enhances scheduling decisions. This capability for live model refinement based on observed task efficacy represents a technical improvement over static or rules-based diagnostic workflows and contributes to the system's automatic self-optimising behaviour.

In the given embodiment, the system 100 is configured for self-improvement through automated updates to the task matrix 136 based on results of completed tasks. When a task is marked complete at step 133 and its outcome is recorded via the task result input, the diagnostic task matrix controller 109 updates the probability values 121 associated with the probable causes 112 and the outcome expectation categorisations 124, based on the result received. This enables the system to refine the underlying diagnostic model over time, based on real-world diagnostic outcomes.

In one embodiment, each diagnostic task 113 is assigned a discrete diagnostic strength indicator, expressed as an integer value from 0 to 5, representing a confidence score. This confidence score is used to quantify the expected informational contribution of the task in resolving a particular fault condition. The confidence score is programmatically converted into a corresponding information weight using the exponential mapping function 2\hat{ }r-1, where r is the confidence score. For example, a score of 5 yields a weight of 31, a score of 3 yields a weight of 7, and a score of 0 yields a weight of 0. This mapping provides a non-linear scaling mechanism whereby tasks with higher confidence scores contribute disproportionately greater influence during diagnostic evaluation.

A resolution sufficiency threshold is defined as an information weight of 31, representing the expected contribution of a highly determinative task. For each fault condition, the total attainable information weight is computed by summing the information weights of all associated tasks, irrespective of completion status. If this total is below the resolution sufficiency threshold, the system determines that additional tasks are necessary to achieve a determinative assessment of that fault condition.

Upon task completion, the system 100 evaluates task result inputs to update the internal diagnostic model. For each fault condition, the system 100 calculates a total completed information weight, a total supporting information weight (i.e. completed tasks with outcomes consistent with the fault condition), and a total uncompleted information weight. The remaining required weight is computed as the difference between the resolution sufficiency threshold and the total completed weight, bounded below by zero. A confidence quotient is then computed for each fault condition using the formula s+pq, where s is the supporting weight, p is the prior probability of the fault condition, and q is the required remaining weight. These confidence quotients are normalised across all fault conditions to yield an updated probability distribution. The revised probabilities are stored by the diagnostic task matrix controller 109 and applied in subsequent task prioritisation and matrix refinement operations.

This probabilistic adjustment mechanism enables the system 100 to automatically improve its accuracy over time, reflecting organisation-specific resolution trends. For instance, in environments where printer issues are frequent, the probability associated with printer-related causes will rise with repeated confirmations. Conversely, in network-failure-prone environments, the system will bias its future scheduling towards network diagnostics.

The system 100 may further compute an optimal traversal path through the diagnostic matrix by evaluating the expected remaining diagnostic cost. For each fault condition, it identifies the lowest-cost subset of pending diagnostic tasks that, if completed, would yield a sufficient aggregate informational weight to meet a defined resolution threshold. The cumulative cost of these task subsets defines a worst-case remaining cost for achieving a determinative resolution. Additionally, the system calculates the opportunity cost of each task as c(1−p), where c is the task's execution cost and p is the aggregated likelihood that the task contributes to resolution across all fault conditions. The expected remaining diagnostic cost is then calculated as w−(a/2), where w is the worst-case remaining cost and a is the total avoidable cost based on current matrix data.

The diagnostic task with the lowest opportunity cost is selected as the next indicated task. However, the system 100 may also evaluate alternate tasks whose expected informational value justifies their selection over the indicated task. The expected value of an alternate task is assessed relative to the theoretical value of perfect information, which is calculated by simulating the cost incurred by an idealised system that has foreknowledge of the correct fault condition and selects only the minimal sufficient task set. The difference between the expected cost of the current diagnostic plan and this ideal cost represents the value of perfect information. The alternate task's utility is then computed as (pa/s)−c, where p is the value of perfect information, a is the alternate task's weighted informational contribution, s is the resolution sufficiency threshold, and c is the task's cost. If this utility exceeds the opportunity cost of the current indicated task, the system dynamically reprioritises the alternate task, allowing for improved diagnostic sequencing with respect to cost-efficiency and informational yield.

These computational procedures are performed programmatically by the task scheduling controller 110 and the diagnostic task matrix controller 109 operating on the data stored in the storage media 105. Through this integrated technical architecture, the system 100 continuously and automatically adapts to real-world diagnostic data, thereby improving the speed, accuracy, and cost-efficiency of issue resolution in technical support environments.

In further embodiments, the diagnostic task schedule optimising system 100 incorporates a statistical learning model executed by the processor 104 for the purpose of refining the diagnostic task matrix 136 based on historical diagnostic outcomes. The statistical learning model may be implemented as part of the diagnostic task matrix controller 109 or as a separate machine learning module operably interfaced with the diagnostic task matrix controller.

The statistical learning model may include, for example, a Bayesian inference network or a supervised neural network. In the Bayesian implementation, the model defines probabilistic dependencies between observed diagnostic outcomes and underlying probable causes. The system maintains a conditional probability distribution that is iteratively updated as new diagnostic task results are received via the task result input. For each issue ticket 114, the model analyses the pattern of completed diagnostic tasks, associated support values, and final resolution outcomes to update the posterior probabilities of each probable cause 112. These posterior probabilities are then propagated to the diagnostic task matrix 136 to refine the probability values 121 associated with future tickets of the same or similar type.

In alternative embodiments, the statistical learning model comprises a neural network trained on historical resolution data stored in the storage media 105. The input layer of the neural network may receive feature vectors comprising issue ticket metadata, task identifiers, prior probabilities, recorded outcomes, diagnostic durations, and personnel identifiers. The output layer generates updated probability distributions over the set of probable causes 112. The model is trained using labelled historical resolution data, including ground-truth labels indicating the actual cause of each issue. The trained model is applied in real-time to incoming issue tickets to generate refined, data-driven initial probability distributions for the associated task matrix 136.

In either implementation, the statistical learning model enables the system 100 to identify patterns in diagnostic resolution outcomes that vary across different environments, such as distinct organisations or departments. For example, in an organisation where older peripheral hardware is prevalent, the model may detect a correlation between print-related tickets and hardware faults, thereby biasing future probability estimates toward printer malfunction in similar contexts. In contrast, in network-centric environments, the model may converge toward higher prior probabilities for network-related causes. This adaptability allows the system to autonomously customise its diagnostic prioritisation logic based on empirical data specific to each deployment environment.

The continual training and inference process of the learning model is carried out by the processor 104 in conjunction with data retrieved from the storage media 105. Model parameters may be periodically retrained in batch mode or updated incrementally using online learning techniques, depending on the available computational resources and the volume of incoming data. Updated model outputs are written back into the diagnostic task matrix 136 by the diagnostic task matrix controller 109, providing a closed-loop feedback mechanism for automatic optimisation of diagnostic task scheduling.

In embodiments, the task scheduling controller 110 is further configured to dynamically generate task schedules based not only on the current diagnostic task matrix 136 but also on accumulated historical task outcomes, technical skill availability, and resource constraints. This dynamic scheduling mechanism is implemented as an iterative computational process, wherein previously resolved tickets and their associated task sequences are analysed to identify which diagnostic actions most efficiently resolved particular classes of issues.

The historical resolution data, including task result inputs and time-to-resolution metrics, are stored within the storage media 105 and are accessible by the processor 104 during schedule generation. The task scheduling controller 110 applies weighting to candidate diagnostic tasks based on their historical efficiency in resolving issues with similar probable cause profiles. In doing so, the system prioritises task sequences that have demonstrated high resolution efficacy, thereby reducing the assignment of low-value or redundant tasks that consume time and resources without contributing meaningfully to issue resolution.

In parallel, the task scheduling controller 110 evaluates real-time availability of technical personnel by interfacing with the calendaring server 122.

Personnel schedules are queried via the data interface 119, and availability windows are retrieved for the required technical capabilities associated with each task. These availability constraints are factored into the scheduling algorithm to ensure that tasks are assigned to personnel who are both appropriately skilled and available within the relevant timeframe.

Resource constraints, including task duration and cost parameters defined within the matrix 136, are incorporated into a constrained optimisation routine. This routine seeks to minimise the cumulative expected cost and duration of the diagnostic process while maximising the probability of resolution. The optimisation is subject to technical skill availability, real-time calendaring constraints, and the calculated evidentiary value of each task as previously described.

By integrating these factors, the task scheduling controller 110 generates a task execution sequence that is contextually optimised for the specific operational environment. This dynamic, data-driven scheduling approach leads to measurable improvements in system-wide performance, including increased uptime of computing infrastructure, reduced average ticket resolution time, and higher throughput of technical support resources. In particular, the system reduces duplicated effort by avoiding reassignment of previously ineffective tasks and ensures that available personnel are used in a resource-optimal manner, thereby improving helpdesk responsiveness and diagnostic efficacy at scale.

In further embodiments, the system 100 interfaces directly with one or more live calendaring servers 122 to retrieve personnel availability data in real time. The calendaring server 122 may be implemented using enterprise scheduling infrastructure such as Microsoft Exchange Server, Google Calendar, or any suitable calendaring system that exposes calendar event data through an application programming interface (API). The server 101 communicates with the calendaring server 122 via the data interface 119 and queries calendar records associated with personnel required to perform diagnostic tasks 113 listed in the task matrix 136.

For each diagnostic task 113, the required technical capabilities are defined within the matrix 136 as part of the associated required resources 120. The task scheduling controller 110 maps these capabilities to specific personnel resources and identifies time windows during which those personnel are available. The personnel calendars may contain a combination of recurring availability patterns, scheduled meetings, absences, or dynamically updated availability status, all of which are programmatically evaluated by the processor 104 at the time of task schedule generation.

The retrieved availability data is used as a live constraint during the optimisation routine performed by the task scheduling controller 110. If a required resource is unavailable within a target resolution window, the controller dynamically adjusts the task order or reassigns the task to an alternate resource if one is available. These updates are performed automatically and can be recalculated upon any change in calendar data, such as the scheduling or cancellation of meetings. In this way, the system continuously reflects up-to-date team availability and adapts task schedules accordingly without manual intervention.

The dynamic nature of this scheduling process enables real-time adaptation to personnel constraints that would otherwise be difficult or impractical to manage manually, particularly in large organisations or multi-site deployments. The latency and complexity of manually reconciling live calendar changes across distributed support teams, especially when combined with diagnostic prioritisation and resource optimisation, renders manual scheduling infeasible at scale. By automating the calendar integration and incorporating real-time availability into task scheduling logic, the system ensures high responsiveness, efficient task allocation, and minimal scheduling conflict, thereby improving both diagnostic performance and operational efficiency.

In yet further embodiments, the server 101 is configured to aggregate resolution data from a plurality of client endpoints distributed across an enterprise network. Each client endpoint may include a computer terminal 102 operating in a distinct geographic location, organisational department, or network segment, and configured to transmit issue ticket data and diagnostic task results to the central server 101 over the wide area network 103. These client endpoints contribute diagnostic task completion data and task result inputs, which are received and stored within the storage media 105 as part of the associated data 135.

The ticket controller and diagnostic task matrix controller 109 operate in conjunction with a resolution data aggregator module, which consolidates the incoming data from distributed endpoints into a unified resolution dataset. This dataset includes, for each resolved ticket, the associated probable causes, diagnostic task sequence, completion outcomes, timestamps, personnel assignments, and final resolution labels. The system further tags each record with contextual metadata identifying the originating endpoint, such as geographic region, department identifier, or system configuration profile.

Using this aggregated resolution dataset, the system periodically refines the diagnostic task matrix 136. The refinement may involve recalculating the prior probabilities 121 associated with probable causes 112, updating the outcome expectation categorisations 124 for each diagnostic task 113, and modifying resource estimates such as typical task durations or resolution rates. The refinement process may be executed at fixed intervals, on-demand, or in response to statistically significant data accumulation from new endpoints.

The aggregation and analysis of resolution data across distinct operational environments enables the system to detect and adapt to patterns that are specific to particular segments of the organisation. For example, endpoint data from a finance department may indicate a higher incidence of software configuration issues, whereas endpoints in a print-heavy production environment may exhibit a greater frequency of hardware-related faults. The system can adjust the task matrices accordingly, so that incoming tickets from each segment are triaged and scheduled based on segment-specific diagnostic trends rather than global averages.

This distributed data aggregation and matrix refinement architecture allows the system 100 to maintain high diagnostic precision across heterogeneous computing environments. By tailoring the probability models and task prioritisation strategies to the historical performance of each segment, the system delivers targeted diagnostic recommendations that reflect the real-world operational characteristics of each deployment context. This multi-source learning capability further enhances the automatic self-improving nature of the system, ensuring that it remains optimised even as organisational infrastructure evolves over time.

In additional embodiments, the user interface 116 is configured to support live drag-and-drop reconfiguration of the diagnostic task matrix 136. This functionality is implemented by the user interface controller 108 in conjunction with the diagnostic task matrix controller 109 and enables authorised users to modify the association between diagnostic tasks 113 and probable causes 112 via direct manipulation of interface elements displayed on the digital display 115.

Through the drag-and-drop interface, a user may reassign a diagnostic task to a different probable cause, modify the execution order of tasks associated with a given cause, or alter the relative priority of tasks. The interface presents each task and its associated metadata-including required resources, expected time, cost, and outcome expectation categorisation-in a structured matrix or list format. As a task is repositioned or reassigned, the user interface controller 108 captures the interaction event and transmits the update to the diagnostic task matrix controller 109 in real time.

Upon receiving the input, the diagnostic task matrix controller 109 performs a dynamic update of the affected matrix data. Specifically, the reassignment or reordering of tasks triggers automatic recalculation of the probability values 121, expected resolution costs, and supporting evidence values associated with the affected probable causes. These recalculations are performed by the processor 104 using the updated task configuration and the computational models described previously, including the evidence value model and the probabilistic update mechanism. The updated values are immediately written to the storage media 105 and persistently stored as part of the diagnostic matrix state.

This live editing capability enables real-time scenario modelling and matrix tuning by administrators or experienced operators. For example, a user may introduce a new diagnostic task into an existing workflow and immediately observe the impact on overall diagnostic confidence, expected cost, and task priority. Similarly, the drag-and-drop mechanism allows for rapid restructuring of diagnostic workflows in response to emerging issue trends, infrastructure changes, or updated support protocols, without the need for offline editing or system downtime.

The real-time propagation of matrix updates ensures that all subsequent processing, including task schedule generation by the task scheduling controller 110 and statistical model inference, is based on the most current matrix configuration. This capability significantly enhances the responsiveness and adaptability of the system, supporting agile refinement of diagnostic strategies within dynamic operational environments.

In further embodiments, the task scheduling controller 110 is configured to compute an optimal traversal path through the diagnostic task matrix 136 by solving a constrained optimisation problem. The objective of this optimisation is to identify a sequence of diagnostic tasks 113 which, when executed, minimises the expected total resolution time for a given issue ticket 114, subject to constraints including technician availability, task success likelihoods, and task-specific resource cost functions.

The optimisation process operates on the current state of the diagnostic task matrix 136, which includes the updated probabilities 121 assigned to each probable cause 112, the outcome expectation categorisations 124 for each diagnostic task 113, and the associated required resources 120. These resources may include expected task durations, technician skill requirements, and cost parameters reflecting labour rates or resource usage fees. Technician availability windows are obtained in real time from the calendaring server 122, as previously described, and define scheduling constraints based on personnel availability over a specified planning horizon.

The optimisation problem is modelled as a constrained scheduling graph in which each node represents a diagnostic task and each edge represents a possible transition between tasks. The cost function for each task includes both the expected execution time and a weighting derived from the inverse of the task's success likelihood. Tasks with higher likelihoods of resolving the issue, as determined from historical resolution data or statistical inference models, are weighted more favourably in the traversal path.

The task scheduling controller 110 applies a heuristic or exact optimisation algorithm, such as a branch-and-bound search, a constrained dynamic programming solver, or a linear programming relaxation depending on computational resource availability. The optimisation algorithm selects a path through the graph which meets all scheduling constraints while minimising the aggregate cost function. The resulting path represents the optimal order in which tasks should be performed to achieve resolution in the shortest expected time and with minimal resource expenditure.

Once computed, the optimal task sequence is stored within the storage media 105 and presented to the user interface 116 as a recommended action plan. The sequence remains dynamically updateable in response to new task result inputs, technician schedule changes, or reconfiguration of the matrix. This continuous optimisation capability ensures that the diagnostic process remains aligned with real-world constraints and resolution likelihoods, allowing the system to provide technical support workflows that are both efficient and cost-effective. The formalisation of the task scheduling process as a constrained optimisation problem further reinforces the technical character of the invention, distinguishing it from rule-based or manually prioritised approaches.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A diagnostic task schedule optimising system comprising a processor operably interfacing with storage media comprising application controllers and data, the application controllers comprising:
a ticket controller configured to receive and store issue tickets within the storage media;
a diagnostic task matrix controller configured to associate a diagnostic task matrix with each issue ticket, the diagnostic task matrix comprising a plurality of probable causes each associated with a probability, and a plurality of diagnostic tasks each associated with one or more of the probable causes, wherein each diagnostic task is associated with required resources and an outcome expectation categorisation indicating an expected likelihood that the task will resolve one or more of the probable causes;
a user interface controller configured to display a user interface on a digital display, the user interface comprising data input fields for editing data values of the diagnostic task matrix and a task completion input configured to record completion of a diagnostic task, the task completion input comprising a task result input indicating whether the task resolved the issue; and
a task scheduling controller configured for analysing the required resources, probabilities, and outcome expectation categorisations of the diagnostic task matrix to optimise priority of the diagnostic tasks,
wherein the diagnostic task matrix controller is further configured to update the probabilities and the outcome expectation categorisations based on the task result inputs received via the user interface.

2. The system as claimed in claim 1, wherein the required resources include a time requirement, a cost requirement, and a technical capability requirement.

3. The system as claimed in claim 1, wherein the system interfaces with a calendaring server and the required resources include time availability data retrieved in real time from the calendaring server.

4. The system as claimed in claim 1, wherein the diagnostic task matrix further comprises priority values assigned to one or more of the diagnostic tasks, and the task scheduling controller is configured to optimise the task scheduling based at least in part on the priority values.

5. The system as claimed in claim 1, wherein the diagnostic task matrix controller is further configured to assign each diagnostic task a diagnostic strength indicator, the diagnostic strength indicator being used to compute a weighted informational contribution via an exponential weighting function.

6. The system as claimed in claim 5, wherein the diagnostic task matrix controller is configured to compute updated probabilities for each probable cause by applying a normalised confidence quotient derived from the weighted informational contributions of completed tasks and the corresponding task result inputs.

7. The system as claimed in claim 1, wherein the task scheduling controller is configured to determine an optimal traversal path through the diagnostic task matrix by solving a constrained optimisation problem minimising an objective function comprising expected task duration, task cost, and likelihood of success.

8. The system as claimed in claim 7, wherein the constrained optimisation problem includes constraints based on technician availability, cost limits, and minimum aggregate informational contribution thresholds.

9. The system as claimed in claim 1, wherein the application controllers comprise a statistical learning model implemented using a Bayesian network or neural network, the statistical learning model being trained on historical task outcomes stored in the storage media.

10. The system as claimed in claim 9, wherein the statistical learning model is configured to generate updated probability values for probable causes based on historical task outcomes, ticket metadata, and recorded resolution labels.

11. The system as claimed in claim 9, wherein the statistical learning model is further configured to output updated outcome expectation categorisations for diagnostic tasks based on the training data.

12. The system as claimed in claim 1, wherein the task scheduling controller is configured to analyse historical resolution data stored in the storage media to adjust task ordering, reduce task duplication, and improve diagnostic throughput.

13. The system as claimed in claim 1, wherein the task scheduling controller is configured to receive updated technician availability data from the calendaring server and dynamically reschedule tasks in response to near-instantaneous calendar changes.

14. The system as claimed in claim 1, wherein the diagnostic task matrix controller is further configured to aggregate resolution data from a plurality of distributed client endpoints and to refine the diagnostic task matrix based on patterns detected across distinct endpoint groups.

15. The system as claimed in claim 14, wherein the diagnostic task matrix controller is configured to tag resolution data with endpoint metadata comprising geographic or organisational identifiers and apply segment-specific refinement to probability values and task associations.

16. The system as claimed in claim 1, wherein the user interface supports drag-and-drop reconfiguration of diagnostic task associations and execution ordering, and the diagnostic task matrix controller is configured to update associated probability values and cost metrics in real time based on such user interactions.

17. The system as claimed in claim 16, wherein the updated values resulting from user interface reconfiguration are immediately written to the storage media and applied to subsequent task scheduling operations.

18. The system as claimed in claim 1, wherein the task scheduling controller is configured to compute an opportunity cost for each diagnostic task based on cost and resolution likelihood contribution, and to select the diagnostic task with the lowest opportunity cost as the next indicated task.

19. The system as claimed in claim 18, wherein the task scheduling controller is further configured to evaluate alternate diagnostic tasks by estimating an expected value based on the value of perfect information and to override the indicated task if an alternate task offers a higher expected utility.

20. The system as claimed in claim 1, wherein the application controllers comprise a cost calculation controller configured to compute an expected remaining diagnostic cost for resolving an issue ticket based on the selected subset of diagnostic tasks and their associated probabilities, durations, and costs.
